(19) United States
(12) Patent Application Publication
(10) Pub. No.: US 2020/0316657 A1
(43) Pub. Date: Oct. 8, 2020

(54) CLEAN-IN-PLACE USING ULTRASOFT WATER

(71) Applicant: Ecolab USA Inc., Saint Paul, MN (US)

(72) Inventors: Anthony Erickson, Golden Valley, MN (US); Lawrence Grab, Minneapolis, MN (US)

(21) Appl. No.: 16/839,174

(22) Filed: Apr. 3, 2020

Related U.S. Application Data
(60) Provisional application No. 62/830,232, filed on Apr. 5, 2019.

(51) Int. Cl. B08B 9/032; C11D 11/00; C11D 3/04; C02F 1/52; C02F 1/44; C02F 1/42

(52) U.S. Cl. CPC B08B 9/032; C11D 11/0041; C11D 3/044; C02F 2303/26; C02F 1/441; C02F 1/42; C02F 1/52

(57) ABSTRACT

A clean-in-place (CIP) process can utilize ultrasoft water during one or more steps of the process to improve overall cleaning efficacy. Ultrasoft water can exhibit extremely low levels of calcium and magnesium. Performing a CIP process with ultrasoft water may provide cleaning improvements as compared to merely using soft water.

### RELATED MATTERS

This application claims the benefit of U.S. Provisional Patent Application No. 62/830,232, filed Apr. 5, 2019, the entire contents of which are incorporated herein by reference.

### TECHNICAL FIELD

This disclosure relates to clean-in-place (CIP) technology and, more particularly, to CIP treatment using ultrasoft water.

### BACKGROUND

A clean-in-place (CIP) process is a cleaning technique adapted to remove soils from the internal components of industrial equipment, such as processing tanks, fluid lines, pumps, valves, heat exchangers, and other pieces of equipment. A CIP cleaning process cleans the internal surfaces of these components without the need to dismantle any of the components for individual cleaning. Rather, the components can be cleaned by passing a cleaning solution through the components, for example following a fluid path normally traveled by a fluid processed on the equipment, to clean the components.

Because of its ease of use and effectiveness, CIP cleaning processes have found widespread applicability in many different industries, particularly those industries where hygiene and sterility are of particular importance. Example industries that use CIP cleaning processes include dairy, beverage, brewing, processed food preparation, pharmaceuticals, and cosmetics. In these and other industries, internal surfaces of processing equipment can become contaminated with soil during operation. To help ensure the operational efficiency of the processing equipment and to prevent soil buildup from contaminating product produced on the equipment, the processing equipment is periodically cleaned using a CIP process.

During various steps of the CIP process, the components of the processing equipment are typically cleaned with water and/or various chemical cleaning agents. The amount of time required to adequately clean equipment during a specific CIP process may vary based on factors such as the aggressiveness of the soil contaminating the components, the strength of the chemical cleaning agents used, and the level of sanitation required after cleaning. Regardless of the cleaning conditions used, the liquid used to clean the equipment during the CIP process may be disposed of after use. For example, the liquid may be sent to a waste water treatment facility for processing before environmental discharge. In general, increasing the amount of chemical cleaning agent used during the CIP process may increase the cleaning efficacy and/or reduce the amount of cycle time needed for cleaning. However, increasing the amount of chemical cleaning agent used during the CIP process can increase the cost and present waste water processing challenges downstream.

### SUMMARY

In general, this disclosure relates to CIP processes performed using ultrasoft water. The softness of water refers to the amount of certain ions present in the water, such as calcium and magnesium, with soft water having low amounts of these ions and hard water having high amounts of these ions. On a scale of water hardness, for example, water having less than 100 ppm calcium and magnesium may be considered soft while water having more than 320 ppm calcium and magnesium may be considered very hard.

As discussed in greater detail in connection with the working example, the Applicant has identified enhanced cleaning effectiveness when performing a CIP process using ultrasoft water. Ultrasoft water is different from water that is merely characterized as soft water in that the ultrasoft water has extremely low levels of certain ions. In some applications, the Applicant has identified a non-linear improvement in cleaning effectiveness that is achievable when performing a CIP process using ultrasoft water. For example, an inflection point in cleaning efficacy has been observed by the Applicant when experimenting with ultrasoft water whereby cleaning performance significantly improves when transitioning from conducting a CIP process using soft water to conducting the CIP process using ultrasoft water. Accordingly, aspects of the present disclosure leverage this insight to provide improved CIP systems and techniques.

In some implementations, a CIP process performed using ultrasoft water according to the disclosure allows corresponding changes to be made to the process to leverage the cleaning performance improvements achievable. For example, the CIP process may be performed using a lower concentration of chemical cleaning agent than is used in a typical CIP process. This may lower the operating cost for the CIP process user and/or provide downstream processing advantages, such as reducing the demand on a downstream waste water treatment system. As another example, the CIP process may be performed without adding (or adding a minimal amount) of a water hardness control agent that is designed to inactivate minerals present in the water during cleaning. This can help limit the cost and complexity of the CIP process and may also help prevent unexpected chemical interactions that may sometimes occur when adding additional chemical components to a processing stream. In addition, water hardness control agents may cause downstream waste water processing challenges which can be minimized or eliminated by limiting the use of the agents. CIP systems and techniques using ultrasoft water can have a variety of additional or different features and aspects, as described herein.

In one example, a method of performing a clean-in-place (CIP) process is described. The method includes flushing industrial equipment with a cleaning fluid comprising at least one cleaning agent and an ultrasoft water having a hardness of less than 35 parts per million of calcium and magnesium. The method also includes, subsequent, to flushing the industrial equipment with the cleaning fluid, flushing the industrial equipment with a rinse fluid to rinse the chemical agent from the industrial equipment.

Some implementations of this method further include prior to flushing the industrial equipment with the cleaning fluid, generating the cleaning fluid by at least receiving water from a supply source having a hardness greater than 35 parts per million of calcium and magnesium, conditioning the water from the supply source to reduce the hardness, thereby generating the ultrasoft water, and combining the cleaning agent with the ultrasoft water. For example, the water received from the supply source may be conditioned using one or more of chemical precipitation, ion exchange, and reverse osmosis. The supply source may be a municipal water source or well and, in some examples, can have a hardness greater than 65 parts per million of calcium and magnesium.

In another example, a system is described that includes industrial equipment, a water conditioner, a source of a cleaning agent, and a fluid pump. The industrial equipment has a fluid inlet and a fluid outlet. The water conditioner is configured to receive water from a supply source and reduce a hardness of the water to less than 35 parts per million of calcium and magnesium, thereby generating an ultrasoft water. The fluid pump is configured to receive the ultrasoft water and the cleaning agent, pressurize a cleaning fluid comprising the ultrasoft water and the cleaning agent, and convey the pressurized cleaning fluid through the industrial equipment from the fluid inlet to the fluid outlet.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is an illustration of an example clean-in-place (CIP) system.

FIG. 2 is graph showing percentages of clean after wash for four experimental cleaning solutions evaluated where each cleaning solution was formulated from water having a different hardness level.

FIG. 3 is a plot of experimental data with extrapolations illustrating a change in cleaning performance around 2 grains of hardness for the experimental conditions.

### DETAILED DESCRIPTION

The present disclosure is generally directed to systems, devices, and techniques for cleaning of industrial equipment using a clean-in-place (CIP) process utilizing ultrasoft water. The number of cleaning steps performed during a CIP process can vary depending on the specific process being performed. At minimum, a cleaning fluid is passed through the equipment before resuming normal processing. Any product subsequently passed through the equipment that becomes contaminated by cleaning fluid residue can be discarded. More typically, however, the CIP process involves at least three steps. In the first step, which may be referred to as a pre-flush or pre-rinse step, an aqueous fluid such as fresh water is passed through the processing equipment to flush the system of soil (e.g., residual product in the equipment, product build-up on equipment internals). In the second step, which may be referred to as a cleaning step, a cleaning fluid is passed through the equipment to clean and/or sanitize the equipment. Further, in the third step, an aqueous rinse liquid such as fresh water is passed through the equipment to rinse any cleaning fluid from the equipment.

In accordance with some implementations described in this disclosure, one or more steps of the CIP process are performed using ultrasoft water. For example, a CIP pre-flush step may be performed in which the industrial equipment is flushed with ultrasoft water, optionally containing one or more precleaning additives. Additionally or alternatively, ultrasoft water can be combined with one or more cleaning agents to generate a cleaning fluid that is then passed through the industrial equipment during a CIP cleaning step. The cleaning fluid may be recirculated through the industrial equipment a plurality of times, progressively reducing the amount of soil present on the internal surfaces of the equipment while progressively increasing a concentration of the soil in the recirculating cleaning fluid. Further additionally or alternatively, a CIP rinse step may be performed in which ultrasoft water, optionally containing additives, is flushed through the industrial equipment to rinse residual cleaning fluid from the industrial equipment. Independent of whether ultrasoft water is utilized in only one or in multiple steps of the CIP process, the ultrasoft water may enhance the effectiveness of the CIP process as compared to if the same process was performed without using ultrasoft water.

As used herein, the term “ultrasoft water” refers to water having a hardness less than a threshold value, with various threshold values being specified herein. The hardness is attributable to calcium and magnesium and is measured according to ASTM D1126-02 “STANDARD TEST METHOD FOR HARDNESS IN WATER,” the contents of which are incorporated herein by reference. Hardness values may be reported herein in parts per million (ppm), with 1 ppm being equivalent to 1 mg/L.

As used herein, the term “water hardness control agent” refers to compounds that complex with or inhibit crystallization of water hardness ions to inhibit the negative effects of hardness ions in the water source, such as inhibiting the cleaning performance of a surfactant. Water hardness control agents includes builders, chelating agents, and sequestrants, which are compound that form a complex (soluble or not) with water hardness ions (from the wash water, soil and/or substrates being washed) in a specific molar ratio. Chelating agents that can form a water soluble complex include sodium tripolyphosphate, EDTA, DTPA, NTA, citrate, and the like. Sequestrants that can form an insoluble complex include sodium triphosphate, zeolite A, and the like. Water hardness control agents also include threshold agents, which refers to compounds that inhibits crystallization of water hardness ions from solution, but that need not form a specific complex with the water hardness ion. Threshold agents include a polyacrylate, a polymethacrylate, an olefin/maleic copolymer, and the like.

As used herein, the term “free of water hardness control agents” or “substantially free of water hardness control agents” refers to a composition, mixture, or ingredients that does not contain a water hardness control agent or to which only a limited amount of a water hardness control agent has been added. Should a water hardness control agent be present, the amount of the water hardness control agent(s) present in the use fluid (e.g., cleaning fluid) to be characterized as substantially free of water hardness control agents shall be less than 0.1 weight percent.

As used herein, the term “lacking an effective amount of water hardness control agent” refers to a composition, mixture, or ingredients that contains too little water hardness control agent to measurably affect the hardness of water.

In use, ultrasoft water with or without additional chemical agents can be passed under pressure through industrial equipment during one or more steps of the CIP process. This can result in the removal of soil from the equipment, thereby cleaning and sanitizing the equipment for future use. The term soil as used herein generally refers to the component or components intended to be cleaned from the industrial equipment during the CIP process. Soil may include residual product being flushed from the equipment, built-up product in the equipment (e.g., baked-on product), and/or contaminants in the equipment, among other types of soils.

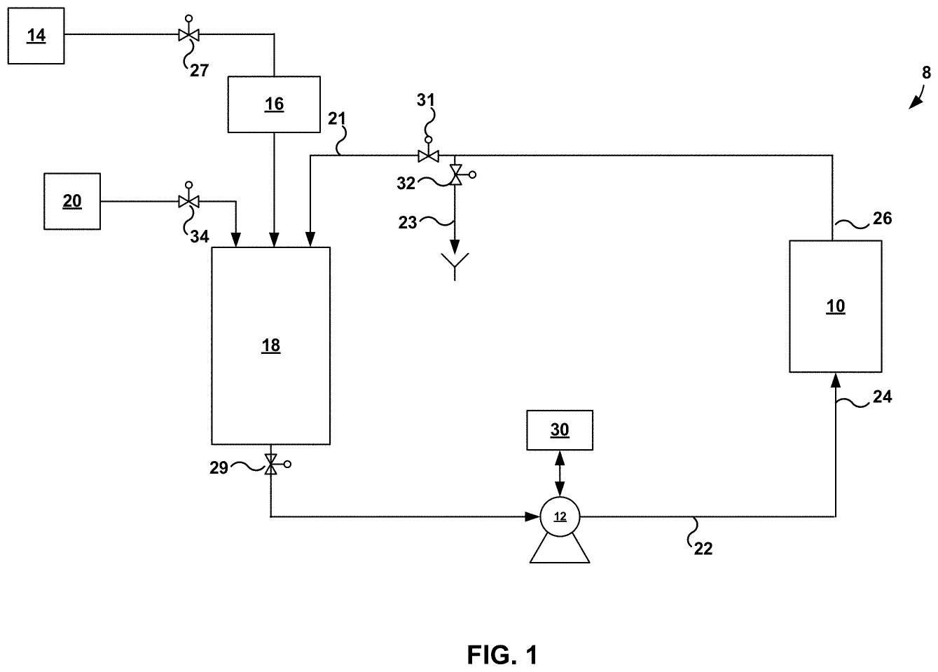

FIG. 1 is an illustration of an example CIP system 8 in which industrial equipment 10 is cleaned in place utilizing ultrasoft water. System 8 includes a pump 12 fluidly connected to a supply source of water 14. Source 14 can supply water to a water conditioner 16 that conditions to water to be ultrasoft. The ultrasoft water can be delivered to a tank 18 that fills with the ultrasoft water and provides a reservoir of fluid from which pump 12 can draw. One or more sources of cleaning agents 20 can provide one or more cleaning agents that also supplied to tank 18, e.g., to intermix with the ultrasoft water and generate a cleaning fluid.

During operation, pump 12 can draw fluid at a suction side of the pump, pressurize the fluid inside of the pump, and discharge the fluid at an elevated pressure into fluid conduit 22. Fluid conduit 22 is connected to a fluid inlet 24 of equipment 10 and conveys pressured fluid from the pump to the equipment. Inside of the industrial equipment 10, the pressurized fluid can contact internal surfaces of the equipment, e.g., for flushing soil from the surfaces, chemically cleaning the surfaces, and/or flushing residual cleaning fluid from the surfaces. Residual fluid having passed through the industrial equipment can discharge through a fluid outlet 26 of the equipment. Fluid exiting industrial equipment 10 during a CIP process can either be returned to tank 18 (or a different tank) via conduit 21 for recirculation or be disposed of to drain via a conduit 23.

CIP system 8 in FIG. 1 is illustrated as including an assortment of valves (28, 29, 31, 32, 34) and fluid conduits that control fluid movement through the system. A controller 30 can manage the overall operation of CIP system 8. Controller 30 may be communicatively coupled to various components within CIP system 8, for example via a wired or wireless connection, so as to send and receive electronic control signals and information between controller 30 and the communicatively coupled components. For example, controller 30 may electronically actuate valves (28, 29, 31, 32, 34) to open/close the valves and control pump 12 to control fluid movement through the system.

Controller 30 can control system 8 to execute and control the various steps of the CIP process, including generating one or more fluids during the CIP process and controlling the timing and delivery of the fluid(s). While process steps of CIP system 8 are described as being executed by controller 30 herein, it should be appreciated that one or more (e.g., all) actions described as being executed by controller 30 may be executed by a human operator (e.g., manually turning valves and/or turning pump 12 on and off) without departing from the scope of the disclosure.

Although FIG. 1 illustrates one particular arrangement of a CIP system, it should be understood that this is only one example. The disclosure is not limited to a CIP system having any particular configuration, much less the particular configuration of FIG. 1. In different examples, CIP system 8 may not include tank 18 or may include multiple tanks, e.g., where one tank holds a pre-rinse and/or rinse fluid and a separate tank holds a cleaning fluid. In some examples, an ultrasoft water holding tank is positioned between water conditioner 16 and mixing tank 18, allowing ultrasoft water to be stored for subsequent use during one or more CIP process steps. Additionally or alternatively, CIP system 8 may include a recirculation and/or recovery tank different from tank 18. For example, tank 18 may be a fresh or new liquid tank whereas a recovery tank may be used to recover liquid after having passed through equipment 10, e.g., for recirculation and/or use as a pre-rinse fluid in a subsequent cycle of CIP cleaning. As yet another example, CIP system 8 may include a heat exchanger, heater, and/or cooler to adjust the temperature of fluids used during the CIP process. CIP system 8 can include additional or different features, as will be appreciated by those of ordinary skill in the art.

For example, during one or more steps of the CIP process (e.g., cleaning step), the fluid passing through the CIP system may be heated above ambient temperature. For example, the fluid may be heated to a temperature ranging from 45 degrees Celsius to 90 degrees Celsius, such as from 50 degrees Celsius to 75 degrees Celsius. Other heating temperatures may be used or CIP system 8 may not deliberately heat the fluid used during the CIP process.

As will be discussed in greater detail below, water conditioner 16 may receive water from source 14 this is not ultrasoft and process the received water to generate ultrasoft water. For example, water conditioner 16 may remove ions from the incoming water, including calcium and magnesium, to generate ultrasoft water have a reduced amount of ions contributing to water hardness as compared to the source water. This ultrasoft water can then be used during one or more phases of the CIP process, such as a pre-rinse phase, a cleaning phase, and/or a rinse phase.

In general, industrial equipment 10 can be cleaned in place (e.g., without disconnecting the equipment from the fluid connections it has during typical operation) using CIP system 8. The CIP process performed by CIP system 8 can be accomplished by passing fluid through industrial equipment 10. While mechanical scrubbing can also be performed, typically CIP is performed without mechanical action or contact with the internal surfaces of the equipment being cleaned (e.g., industrial equipment 10) during CIP processes, only fluid contact. In either case, executing under the control of controller 30, CIP system 8 may perform a multistep cleaning process that involves passing multiple different fluids through industrial equipment 10 to arrive at a resultant clean state. For example, CIP system 8 may execute a cleaning process that initially utilizes a pre-rinse fluid followed by a cleaning fluid and further followed by a rinse fluid.

Pre-rinse fluid may be a fluid that functions to rinse soil from within industrial equipment 10, helping to eliminate soil residues within the equipment and prepare the equipment for subsequent flushing with a cleaning fluid. Pre-rinse fluid is typically water (e.g., may consist or consist essentially of water), although may include pretreatment additives. Example pretreatment fluids are described in US Patent Publication No. 2008/0105279, titled “Methods for Cleaning Industrial Equipment with Pre-Treatment,” which is assigned to the same assignee as the present application and the entire contents of which are incorporated herein by reference for all purposes. When pre-rinse fluid is water, the water may be ultrasoft water generated by water conditioner 16. Alternatively, when the pre-rinse fluid is water, the water may be fresh water supplied from source 14 that is not softened by water conditioner 16 down to an ultrasoft level (non-ultrasoft water) or may be water that is reused from a different process at the location of industrial equipment 10 (e.g., condenser water).

In some examples, pre-rinse fluid is passed through industrial equipment 10 only a single time before being discarded to drain via conduit 23. In other examples, the pre-rinse fluid is recirculated through CIP system 8 via conduit 21 so the fluid passes through tank 18 (or a different tank), pump 12, and industrial equipment 10 multiple times. During each successive pass through the industrial equipment, the pre-rinse fluid may release more soil from the industrial equipment. Recirculating pre-rinse fluid through industrial equipment 10 can help conserve the amount of fluid consumed during the pre-rinse step. Independent of whether the pre-rinse fluid is recirculated through industrial equipment 10 or passed through the equipment only a single time, the fluid may be discarded to drain at the end of the pre-flushing step.

Cleaning fluid used to clean industrial equipment 10 during a CIP cleaning step can be generated from ultrasoft water produced by water conditioner 16 and one or more concentrated chemical agents 20. Under the control of controller 30, water conditioner 16 can receive water from source 14 and process the received water to generate ultrasoft water. The ultrasoft water can be supplied to tank 18 (e.g., via an intermediate ultrasoft water holding tank) and combined with one or more chemical agents 20 to generate a cleaning fluid.

For example, operating under the control of controller 30, a target amount of one or more concentrated chemical agents 20 can be dispensed into tank 18 along with a target amount of ultrasoft to generate a dilute cleaning fluid that is flushed through industrial equipment 10. Example chemical agents 20 that can be used during the CIP process are described in greater detail below and can include, but are not limited to, an alkaline source (e.g., sodium hydroxide, potassium hydroxide), triethanol amine, diethanol amine, monoethanol amine, sodium carbonate, morpholine, sodium metasilicate, potassium silicate, an acidic source, such as a mineral acid (e.g., phosphoric acid, sulfuric acid) and/or an organic acid (e.g., lactic acid, acetic acid, hydroxyacetic acid, citric acid, glutamic acid, glutaric acid, gluconic acid). In addition, although CIP system 8 is illustrated as only having a single concentrated chemical 20, in other examples, the system may include multiple concentrated chemicals that are used either alone or in combination.

For example, CIP system 8 may perform multiple cleaning phases that include an alkaline wash and an acid wash. During the alkaline wash, controller 30 may combine one or more concentrated chemical agents (e.g., with ultrasoft water) in tank 18 to generate an alkaline detergent. Controller 30 can control pump 12 (e.g., along with valves in system 8) to pass the alkaline detergent through industrial equipment 10. The alkaline detergent may help dissolve fat, proteins, and hard deposits, among other components. An intermediate water rinse may or may not be performed on the equipment after the alkaline detergent wash by controller 30. In either case, controller 30 may combine one or more concentrated chemical agents (e.g., with ultrasoft water) in tank 18 to generate an acidic detergent. Controller 30 can control pump 12 (e.g., along with valves in system 8) to pass the acidic detergent through industrial equipment 10. The acidic detergent may remove mineral deposits from the equipment and neutralize remaining alkaline detergent on the surfaces of the equipment.

Independent of the number of different cleaning phases using different cleaning agents performed during the CIP cleaning step, each cleaning fluid may be passed through industrial equipment 10 only a single time before being discarded to drain via conduit 23 or may be passed through the industrial equipment multiple times. For example, the cleaning fluid may be recirculated through CIP system 8 via conduit 21 so the fluid passes through tank 18 (or a different tank), pump 12, and industrial equipment 10 multiple times. During each successive pass through the industrial equipment, the cleaning fluid may release more soil from the industrial equipment. Recirculating cleaning fluid through industrial equipment 10 can help conserve the amount of fluid consumed during the pre-rinse step. Independent of whether the cleaning fluid is recirculated through industrial equipment 10 or passed through the equipment only a single time, the fluid may be discarded to drain at the end of the pre-flushing step.

Rinse fluid used in CIP system 8 is typically water (e.g., may consist or consist essentially of water), although may include additives and/or other fluids can be used as a rinse fluid. When the rinse fluid is water, the water may be ultrasoft water generated by water conditioner 16. Alternatively, when the rinse fluid is water, the water may be fresh water supplied from source 14 that is not softened by water conditioner 16 down to an ultrasoft level (non-ultrasoft water). In still other examples, product to be processed using equipment 10 is passed through equipment 10 following a CIP cleaning step and the product initially passed through the equipment (which may pick up residual chemical agent) is discarded.

Independent of the specific type of rinse fluid used, following a cleaning step of a CIP process, the rinse fluid can be passed through industrial equipment 10 to flush the equipment of any residual chemical agent remaining in the equipment. This can prepare the industrial equipment to again process product. In some examples, rinse fluid is passed through industrial equipment 10 only a single time before being discarded to drain via conduit 23. In other examples, the rinse fluid is recirculated through CIP system 8 via conduit 21 multiple times before being discarded to drain.

In general, fluid used during the CIP process (e.g., pre-rinse fluid, cleaning fluid, rinse fluid) are liquid-phase fluids. However, one or more of the fluids may be a gas-phase fluid or include both liquid and gas phases. For example, a fluid used during the CIP process that is ultrasoft water or that includes ultrasoft water (e.g., cleaning fluid comprising both ultrasoft water and one or more chemical agents) may be heated to generate a gas phase (e.g., steam) that is passed through industrial equipment 10. Example multiphase CIP treatment techniques that can be performed using ultrasoft water according to the disclosure are described in US Patent Publication No. 2005/0183744, titled “Method for Treating CIP Equipment and Equipment for Treating CIP Equipment,” which is assigned to the same assignee as the present application and the entire contents of which are incorporated herein by reference.

To initiate a CIP cleaning process, controller 30 may receive a CIP request requesting that a CIP cleaning procedure be performed on industrial equipment 10. In response to the request, controller 30 can control CIP system 8 to initiate a sequence of cleaning steps on industrial equipment 10. Controller 30 may control value 27 to deliver water from water source 14 to water conditioner 16 and, in some configurations, further control the water softener to process the received water to generate ultrasoft water. Controller 30 may generate ultrasoft water from a source water on demand (e.g., in response to a CIP request requesting that a CIP cleaning procedure be performed) or prior to receiving a CIP request (e.g., to maintain an amount of ultrasoft water in a ultrasoft water storage tank).

In either case, controller 30 may initiate a pre-rinse step by controlling components within CIP system 8 to supply tank 18 with ultrasoft water or, in other implementations, non-ultrasoft water from source 14. When the tank is suitably filled, controller 30 can open valve 29 and activate pump 12 to draw the water from the tank and push pressurized water through industrial equipment 10. As the water contacts internal surfaces of industrial equipment 10, the water may flush soil from the industrial equipment. In different examples, controller 30 opens either valve 31 or 32 to direct the water back to tank 18 (or another tank) or to a drain. At the end of the pre-rinse step, controller 30 may close valves 28, 29, 31 and/or 32 and stop pump 12.

Following the pre-rinse step, controller 30 may a cleaning step by controlling components within CIP system 8 to supply tank 18 with ultrasoft water and by opening one or more valves 34 to dispense one or more concentrated chemical agents 20 into tank 18. As discussed above with respect to rinse step, water conditioner 16 may generate ultrasoft water contemporaneous with (e.g., in response to) a request to perform the cleaning step or may generate the ultrasoft water prior to performing the CIP process and/or CIP cleaning step. In either case, when tank 18 is suitably filled with ultrasoft water and one or more cleaning agents to generate a cleaning fluid, controller 30 can open valve 29 and activate pump 12 to draw the cleaning fluid from the tank and push pressurized cleaning fluid through industrial equipment 10. As the cleaning fluid contacts internal surfaces of industrial equipment 10, the cleaning fluid may clean soil from the surfaces of the industrial equipment, sanitize the surfaces, and the like. Controller 30 may open valve 31 to direct the cleaning solution exiting industrial equipment 10 back into tank 18 (or another tank) for recirculation. Within tank 18 the returned cleaning fluid may or may not be blended with flesh concentrated chemical agent(s) and/or ultrasoft water and then discharged for recirculation via pump 12 through industrial equipment 10. At the end of the cleaning step, controller 30 may open valve 32 to discharge the cleaning fluid to drain, stop pump 12.

With the cleaning step complete, controller 30 may initiate a rinse step. Controller 30 may control components within CIP system 8 to supply tank 18 with ultrasoft water or, in other implementations, non-ultrasoft water from source 14. When the tank is suitably filled, controller 30 can open valve 29 and activate pump 12 to draw the water from the tank and push pressurized water through industrial equipment 10. As the water contacts internal surfaces of industrial equipment 10, the water may flush cleaning fluid and any remaining soil from the industrial equipment. Controller 30 may recirculate the water to tank 18 by opening valve 31 or discharge the water to drain by opening valve 32. At the end of the rinse step, controller 30 may and stop pump 12.

In the above-described manner, controller 30 may control CIP system 8 to perform a series of cleaning steps one or more of which utilize ultrasoft water to clean industrial equipment 10 without disassembling or removing the equipment from its location of normal operation. It should be appreciated, however, that the foregoing description of a CIP cleaning process is merely one example and different CIP cleaning processes may be used. For instance, in some applications, the rinse step is omitted from the CIP cleaning process, e.g., to prevent contamination of the equipment with bacteria following the cleaning step.

Ultrasoft water used in one or more steps of a CIP process according to disclosure can be characterized by having an exceptionally low hardness level. For example, without wishing to be bound by any particular theory or experimental conditions, the applicant of the present application has observed an inflection point of CIP cleaning efficacy occurring around two grains per gallons (gpg) of hardness when using waters having different hardness levels. Each grain per gallon of hardness may generally correspond to 17.1 parts per million of hardness. Accordingly, using water during the CIP process having less than about two grains of hardness (e.g., +/−10%) may achieve cleaning efficacy disproportionately more effective than using water having more than this level of hardness.

Accordingly, in various implementations, ultrasoft water used during one or more steps of the CIP process may have a hardness (e.g., attributable to calcium and magnesium) of less than 40 ppm, such as less than 35 ppm, less than 30 ppm, less than 25 ppm, less than 20 ppm, less than 18 ppm, less than 15 ppm, less than 10 ppm, or less than 5 ppm. While the ultrasoft water used during the CIP process may have exceptionally low levels of hardness, the ultrasoft water may or may not be devoid of ions contributing to hardness. For example, the ultrasoft water may have residual calcium and/or magnesium ions that cause the water to exhibit a hardness greater than 0.1 ppm, such as greater than 0.5 ppm, greater than 1 ppm, greater than 2 ppm, greater than 3 ppm, greater than 5 ppm, or greater than 10 ppm. Any of the foregoing mentioned lower concentration values may be observed with any of the foregoing mentioned upper concentration values to provide a range of hardness concentrations. For example, an ultrasoft water used during the CIP process may have a hardness level ranging from 0.1 ppm to 35 ppm, such as from 1 ppm to 35 ppm, or from 1 ppm to 20 ppm, or from 2 ppm to 18 ppm.

Water received from source 14 may exhibit a hardness above that required to be characterized as ultrasoft water for use in a CIP process according to the disclosure. Example sources of water that may be used as source 14 include a municipal water supply (e.g., water supplied from a water treatment plant using underground pipes), a well associated with the facility where industrial equipment 10 is located, or an open environmental source of water (e.g., river, lake). The specific hardness level of the source water may vary based on the geographic location and environmental conditions from where the water was received. For example, depending on the mineral content and composition of the subterranean structure from where the water is extracted, the source water may have varying levels of hardness. As examples, the source water may exhibit a hardness of greater than 30 ppm, such as greater than 40 ppm, greater than 50 ppm, greater than 65 ppm, greater than 100 ppm, greater than 150 parts per million, greater than 200 ppm, or greater than 300 ppm. For example, the source water may exhibit a hardness ranging from 40 ppm to 400 ppm, such as from 40 ppm to 180 ppm. In some implementations, the source water may even generally be considered soft water (e.g., having a hardness level ranging from 40 ppm to 60 ppm) but may not be ultrasoft water.

CIP system 8 includes water conditioner 16, which can receive the source water and process the source water to generate ultrasoft water. Water conditioner 16 may be implemented using any system or technique that reduces the hardness of water provided by source 14. Water conditioner 16 may typically operate by removing the ions from the source water that cause hardness (e.g., calcium, magnesium), instead of sequestering the ions in the water. In various configurations, water conditioner 16 may be implemented using a chemical precipitation system, an ion exchange system, and/or a reverse osmosis system.

In a chemical precipitation system, chemicals are added to the source water to precipitate out calcium and/or magnesium. Example chemicals that may be used in a chemical precipitation system include lime (calcium hydroxide, Ca(OH)₂) and soda ash (sodium carbonate, Na₂CO₃). Lime may be used to remove ions and/or molecules that cause carbonate hardness whereas soda ash can be used to remove ions and/or molecules that cause noncarbonated hardness. For example, hardness caused by calcium may be precipitated as calcium carbonate (CaCO₃). Hardness caused by magnesium may be precipitated as magnesium hydroxide (Mg(OH)₂). After precipitation, the precipitates can be removed by conventional processes such as coagulation/flocculation, sedimentation, and/or filtration. Alternatively, the precipitates may be left in the fluid (e.g., as suspended precipitates) after precipitation to provide ultrasoft water containing precipitated hardness ions. Since the ions contributing to water hardness have been precipitated, the ions do not contribute to the cleaning performance degradation observed with harder water even though the calcium and/or magnesium atom may still be present in the water, albeit in precipitated form.

In an ion exchange system, an ion exchange membrane can be used to exchange divalent cations present in the source water with monovalent cations. For example, an ion exchange system may include an ion exchange resin that is an organic polymer containing anionic functional groups to which the divalent cations (e.g., Mg²⁺, Ca²⁺) bind more strongly than monovalent cations (e.g., K⁺, Na⁺). Inorganic materials called zeolites can also exhibit ion-exchange properties. The source water can be passed over and/or through the membrane to exchange the divalent cations contributing to hardness with monovalent cations. When the available monovalent cations have been replaced with divalent cations (e.g., calcium or magnesium ions), the resin may be recharged by eluting the divalent cations. For example, the resin may be recharged using a solution of sodium chloride or sodium hydroxide, depending on the type of resin used. For anionic resins, regeneration typically uses a solution of, sodium hydroxide (lye) or potassium hydroxide. The waste waters eluted from the ion-exchange column containing the unwanted calcium and magnesium salts are typically the discharged to the sewage system.

In general, reverse osmosis is a water purification technology that uses a hydrostatic force (a thermodynamic parameter) to overcome osmotic pressure (a colligative property) in the water to remove one or more unwanted items from the water. Reverse osmosis may be a membrane based separation process, where the osmotic pressure is overcome by the hydrostatic force, it may be driven by chemical potential, and/or it may be pressure driven. A reverse osmosis membrane may be selective, such that the membrane is sized to not allow large molecules or ions through the pores (holes). In the case of a reverse osmosis system used to generate ultrasoft water, the membrane may have pores large enough to admit water molecules but small enough that hardness ions such Mg′ and Ca′ will not fit through the pores. The resulting water may be free of hardness ions without any other ions being added.

When CIP system 8 utilizes ultrasoft water during a cleaning step of the CIP process, one or more chemical agents 20 can be combined (e.g., mixed) with the ultrasoft water to generate a clean fluid. The selection and use of specific chemical agents may vary depending, e.g., on the industrial equipment being cleaned, the type of soil being removed, the economics of the facility running the CIP process, the temperature of the process, and/or other factors impacting the effectiveness of certain chemical agents compared to other chemical agents. Example chemical agents that may be used during the cleaning process include one or more surfactants, one or more pH adjusters (e.g., an alkaline agent or an acidic agent), one or more enzymes, and/or one or more other additives.

Anionic Surfactants

Anionic surfactants are one class of chemical agent that can be used during the CIP cleaning process. Anionic surfactants are surface active substances having a negative charge on the hydrophobe or have a hydrophobic section that carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility.

Anionic surface active compounds may be useful to impart special chemical or physical properties other than detergency within the composition. Anionics may be employed as gelling agents or as part of a gelling or thickening system. Anionics may also function as excellent solubilizers and can be used for hydrotropic effect and cloud point control.

A majority of large volume commercial anionic surfactants can be subdivided into five major chemical classes and additional sub-groups described in “Surfactant Encyclopedia,” Cosmetics & Toiletries, Vol. 104 (2) 71-86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes phosphoric acid esters and their salts. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like.

Nonionic Surfactant

Nonionic surfactants are another class of chemical agent that can be used during the CIP cleaning process. Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties. Useful nonionic surfactants include:

1. Block polyoxypropylene-polyoxyethylene polymeric compounds such as Pluronic® and Tetronic® manufactured by BASF Corp.

2. Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide such as Igepal® manufactured by Rhone-Poulenc and Triton® manufactured by Union Carbide.

3. Condensation products of one mole of a saturated or unsaturated, straight or branched chain alcohol having from about 6 to about 24 carbon atoms with from about 3 to about 50 moles of ethylene oxide such as Neodol® manufactured by Shell Chemical Co. and Alfonic® manufactured by Vista Chemical Co.

4. Condensation products of one mole of saturated or unsaturated, straight or branched chain carboxylic acid having from about 8 to about 18 carbon atoms with from about 6 to about 50 moles of ethylene oxide such as Nopalcol® manufactured by Henkel Corporation and Lipopeg® manufactured by Lipo Chemicals, Inc.

5. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule such as Pluronic® surfactants manufactured by BASF.

6. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof.

7. The alkylphenoxypolyethoxyalkanols of U.S. Pat. No. 2,903,486 issued Sep. 8, 1959 to Brown et al.

8. Polyhydroxy fatty acid amide surfactants.

9. The alkyl ethoxylate condensation products of aliphatic alcohols

10. The ethoxylated C6-C18 fatty alcohols and C6-C18 mixed ethoxylated and propoxylated fatty alcohols.

11. Suitable nonionic alkylpolysaccharide surfactants include those disclosed in U.S. Pat. No. 4,565,647, Llenado, issued Jan. 21, 1986.

12. Fatty acid amide surfactants.

13. A useful class of non-ionic surfactants include the class defined as alkoxylated amines or, most particularly, alcohol alkoxylated/aminated/alkoxylated surfactants.

Semi-Polar Nonionic Surfactants

The semi-polar type of nonionic surface active agents are another class of nonionic surfactant that may be used during a CIP cleaning process. Semi-polar nonionic surfactants include amine oxides, phosphine oxides, sulfoxides and their alkoxylated derivatives.

Cationic Surfactants

Cationic surfactants are another class of chemical agent that can be used during the CIP cleaning process. Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y- and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants can refer to compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions may themselves be cationic in near neutral to acidic pH solutions and can overlap surfactant classifications. Polyoxyethylated cationic surfactants can behave like nonionic surfactants in alkaline solution and like cationic surfactants in acidic solution.

A majority of large volume commercial cationic surfactants can be subdivided into four major classes and additional sub-groups as described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants may provide desirable properties such a detergency in compositions of or below neutral pH, antimicrobial efficacy, thickening or gelling in cooperation with other agents, and the like.

Amphoteric Surfactants

Amphoteric surfactants are another class of chemical agent that can be used during the CIP cleaning process. Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants may be subdivided into two major classes. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Zwitterionic Surfactants

Zwitterionic surfactants are another class of chemical agent that can be used during the CIP cleaning process. Zwitterionic surfactants can be thought of as a subset of the amphoteric surfactants. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate. Betaine and sultaine surfactants are exemplary zwitterionic surfactants for use herein.

Surfactant Compositions

The surfactants described hereinabove can be used singly or in combination in the practice. For example, the nonionic and anionic surfactants can be used in combination. The semi-polar nonionic, cationic, amphoteric and zwitterionic surfactants can be employed in combination with nonionics or anionics. The selection of particular surfactants or combinations of surfactants can be based on a number of factors, including the desired soil that is encountered on the surface being treated and the intended environmental conditions including temperature and pH.

It should be understood that a cleaning fluid used during the CIP cleaning process need not include a surfactant or a surfactant mixture, and can include other components. In addition, the treatment composition can include a surfactant or surfactant mixture in combination with other components. Exemplary other components that can be provided within the treatment composition include non-aqueous components, adjuvants, enzymes, pH adjusting agents, and bleaching agent.

Non-aqueous components that may be used as a chemical agent in the CIP cleaning fluid include glycols, polyglycols, polyoxides, glycol ethers, aliphatic hydrocarbons, aromatic hydrocarbons, and alcohols. Adjuvants that may be used include those that provide additional desired properties related to, for example, form, function, and/or aesthetics. Example adjuvants that may be used include solubilizing intermediaries called hydrotropes, nonaqueous liquid carrier or solvents, viscosity modifiers, and/or solidifiers. Enzymes that may be used include those that simple proteins or conjugated proteins produced by living organisms and functioning as biochemical catalysts which, in detergent technology, degrade or alter one or more types of soil residues. Proteases, a sub-class of hydrolases, are a class of enzymes commonly used in cleaning applications. A wide variety of other ingredients useful in cleaning fluids can be included in the compositions hereof, including other active ingredients, carriers, draining promoting agents, manufacturing processing aids, corrosion inhibitors, antimicrobial preserving agents, buffers, fluorescent tracers, inert fillers, dyes, etc.

For example, one or more bleaching agents may be used in the cleaning fluid. Bleaching agents include bleaching compounds capable of liberating an active halogen species, such as Cl₂, Bra, —OCl⁻, and/or —OBr⁻, under conditions typically encountered during the treating process. Suitable bleaching agents for use in the present treating compositions include, for example, chlorine-containing compounds such as a chlorine, a hypochlorite, chloramine. Halogen-releasing compounds may include alkali metal dichloroisocyanurates, chlorinated trisodium phosphate, an alkali metal hypochlorites, monochloramine and dichloramine, and the like. A bleaching agent may also be a peroxygen or active oxygen source such as hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like.

A cleaning fluid used during a CIP cleaning step may typically include, although is not required to have, a pH adjusting agent. The pH adjusting agent may be an acidic agent, which reduces the pH of the cleaning fluid, or an alkaline agent, which increases the pH of the cleaning fluid. Exemplary alkaline agents include alkali metal hydroxides, such as sodium hydroxide, potassium hydroxide, and mixtures thereof, alkali metal silicates such as sodium metal silicate, alkaline metal carbonates, alkaline metal bicarbonates, alkaline metal sesquicarbonates, and alkaline metal borates. Sodium hydroxide can be used in an aqueous solution and in a variety of solid forms in varying particle sizes. The carbonate and borate sources are typically used in place of alkaline metal hydroxide when a lower pH is desired.

Exemplary acidifying agents include inorganic acids, organic acids, and mixtures of inorganic acids and organic acids. Exemplary inorganic acids that can be used include mineral acids such as sulfuric acid, nitric acid, hydrochloric acid, and phosphoric acid. Exemplary organic acids that can be used include carboxylic acids including monocarboxylic acids and polycarboxcylic acids such as dicarboxcylic acids. Exemplary carboxylic acids include aliphatic and aromatic carboxylic acids. Exemplary aliphatic carboxylic acids include acetic acid, formic acid, halogen-containing carboxylic acids such as chloroacetic carboxylic acid, and modified carboxylic acids containing side groups such —OH, —R, —OR, -(EO)ₓ, —(PO)ₓ, —NH₂, and/or —NO₂ wherein R is a C₁ to C₁₀ alkyl group. Exemplary aromatic carboxylic acids include benzoic carboxylic acid, salicylic carboxylic acid, and aromatic carboxylic acid modified to include as a side group at least one of halogen, —OH, —R, —OR, -(EO)ₓ, —(PO)ₓ, —NH₂, and/or —NO₂ wherein R is a C₁ to C₁₀ alkyl group. Additional exemplary organic acids include oxalic acid, phthlaic acid, sebacic acid, adipic acid, citric acid, maleic acid, and modified forms thereof containing side groups including halogen, —OH, —R, —OR, -(EO)ₓ, —(PO)ₓ, —NH₂, and/or —NO₂ wherein R is a C₁ to C₁₀ alkyl group. It should be understood that the subscript “x” refers to repeating units. Additional exemplary organic acids include fatty acids such as aliphatic fatty acids and aromatic fatty acids. Exemplary aliphatic fatty acids include oleic acid, palmitic acid, stearic acid, C₃-C₂₆ fatty acids that may be saturated or unsaturated, and sulfonated forms of fatty acids. An exemplary aromatic fatty acid includes phenylstearic acid. Additional acids that can be used include peroxycarboxylic acid such as peroxyacetic acid, and phthalimidopercarboxylic acids. Additional acidic pH adjusting agents include carbon dioxide and ozone.

The specific amounts of the one or more chemical agents used in the cleaning fluid for the CIP cleaning process may vary depending, e.g., on the specific chemical agents selected, the characteristics of equipment 10 to be cleaned, and/or the characteristics of the soil targeted for removal from the equipment. In some implementations, the use of ultrasoft water may facilitate the use of lower levels of chemical agents than may typically be used during a CIP process. In examples, a CIP fluid (e.g., cleaning fluid) may include less than 5 weight percent of alkaline and/or acidic agents, such as less than 2 weight percent of the agents, less than 1 weight percent of the agents, less than 0.5 weight percent of the agents, or less than 0.25 weight percent of the agents. Additionally or alternatively, the CIP fluid may include less than 10 weight percent of surfactants, such as less than 5 weight percent of the surfactants, less than 3 weight percent of the surfactants, or less than 1 weight percent of the surfactants. For example, the amount of surfactants in the CIP fluid may range from 0.05 weight percent to 10 weight percent, such as from 0.1 weight percent to 5 weight percent. The foregoing weight percentages are based on the total weight of the fluid (e.g., as diluted by the ultrasoft water).

The amount of ultrasoft water used to formulate the CIP fluid will vary depending on the concentration amount of chemical agents added to the fluid. Typically, the CIP fluid (e.g., cleaning fluid) may contain greater than 90 weight percent ultrasoft water, such as greater than 95 weight percent ultrasoft water, greater than 98 weight percent ultrasoft water, or greater than 99 weight percent ultrasoft water.

While the cleaning fluid used in the CIP cleaning process may include various chemical agents as discussed above, in some examples, the cleaning fluid is specifically formulated to have low levels of certain components and/or be devoid of certain components. For example, by using ultrasoft water in a pre-rinse fluid, cleaning fluid, and/or rinse fluid, the fluids may be formulated with a minimal amount and/or without water hardness agents. For example, the fluids may be free of water hardness control agents or substantially free of water hardness control agents. Where one or more water hardness control agents are present, in a CIP fluid, the CIP fluid may be lacking an effective amount of water hardness control agent. Of course, in other implementations, a CIP fluid may include an effective amount of one or more water hardness control agents.

With further reference to FIG. 1, CIP system 8 is configured to clean industrial equipment 10. Industrial equipment 10 is conceptually illustrated on FIG. 1 as a single module having an inlet 24 and an outlet 26. The depiction of industrial equipment 10 as a single module is for purposes of illustration and discussion only. It is contemplated that industrial equipment 10 may include one or more individual pieces of industrial equipment (e.g., two, three, four, or more) that each includes an inlet where fluid enters and an outlet where fluid exits. Multiple pieces of industrial equipment can be connected in series to provide a fluid circuit through which fluid travels from one piece of industrial equipment to another piece of industrial equipment. In some examples, industrial equipment 10 defines multiple fluid circuits that each have multiple pieces of industrial equipment connected in series. In such examples, CIP system 8 may have separate pumps and/or fluid conduits fluidly connecting the different fluid circuits to the CIP system 8. Additionally, CIP system 8 may have a fluid/valve manifold to separately connect each of the different fluid circuits to the CIP system.

Examples of individual pieces of industrial equipment 10 include evaporators, separators, fermentation tanks, aging tanks, liquid storage tanks, mash vessels, mixers, pressurized and non-pressurized reactors, driers, heat exchangers. Industrial equipment 10 can also include flow equipment that provides a mechanism for transporting and/or directing a material that is processed, stored, and/or produced during normal operation of the equipment. For example, the flow equipment may include delivery lines, valves, valve clusters, valve manifolds, restrictors, transfer lines (e.g., pipes, conduits), orifices, and pumps.

CIP system 8 is generally located within an industrial plant that processes a product. The industrial plant may provide for the processing, storage, and/or production of various end products. Exemplary industries that may use CIP system 8 include the food industry, the beverage industry, the pharmaceutical industry, the chemical industry, and the water purification industry. In the case of the food and beverage industry, products processed by industrial equipment 10 (and hence the source of soil remaining in the equipment) can include, but is not limited to, dairy products such as whole and skimmed milk, condensed milk, whey and whey derivatives, buttermilk, proteins, lactose solutions, and lactic acid; protein solutions such as soya whey, nutrient yeast and fodder yeast, and whole egg; fruit juices such as orange and other citrus juices, apple juice and other pomaceous juices, red berry juice, coconut milk, and tropical fruit juices; vegetable juices such as tomato juice, beetroot juice, carrot juice, and grass juice; starch products such as glucose, dextrose, fructose, isomerose, maltose, starch syrup, and dextrine; sugars such as liquid sugar, white refined sugar, sweetwater, and insulin; extracts such as coffee and tea extracts, hop extract, malt extract, yeast extract, pectin, and meat and bone extracts; hydrolyzates such as whey hydrolyzate, soup seasonings, milk hydrolyzate, and protein hydrolyzate; beer such as de-alcoholized beer and wort; baby food, egg whites, bean oils, and fermented liquors.

The composition of the soil being cleaned from industrial equipment 10 will vary depending on the application of the industrial equipment. In general, the soil will include some or all of the product(s) most recently processed on industrial equipment 10 prior to initiating the CIP cleaning process. When industrial equipment 10 provides a heated surface (e.g., a heat exchanger, evaporator), the soil may include a thermally degraded rendering of the product(s) most recently processed on the industrial equipment. Example soils may include a carbohydrate, a proteinaceous matter, food oil, cellulosics, monosaccharides, disaccharides, oligosaccharides, starches, gums, proteins, fats, and oils.

Pump 12 in CIP system 8 may be any suitable fluid pressurization device such as a direct lift pump, positive displacement pump, velocity pump, buoyancy pump and/or gravity pump or any combination thereof. In general, components described as valves (28, 29, 31, 32, 34) may be any device that regulates the flow of a fluid by opening or closing fluid communication through a fluid conduit. In various examples, a valve may be a diaphragm valve, ball valve, check valve, gate valve, slide valve, piston valve, rotary valve, shuttle valve, and/or combinations thereof. Each valve may include an actuator, such as a pneumatic actuator, electrical actuator, hydraulic actuator, or the like. For example, each valve may include a solenoid, piezoelectric element, or similar feature to convent electrical energy received from controller 30 into mechanical energy to mechanically open and close the valve. Each valve may include a limit switch, proximity sensor, or other electromechanical device to provide confirmation that the valve is in an open or closed position, the signals of which are transmitted back to controller 30.

Fluid conduits and fluid lines in CIP system 8 may be pipes or segments of tubing that allow fluid to be conveyed from one location to another location in the system. The material used to fabricate the conduits should be chemically compatible with the liquid to be conveyed and, in various examples, may be steel, stainless steel, or a polymer (e.g., polypropylene, polyethylene).

The techniques described in this disclosure, including functions performed by a controller, control unit, or control system, may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, firmware. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for ease of illustration, and does not necessarily require realization of such features by separate hardware, firmware, or software components. In some cases, various units may be implemented as programmable processes performed by one or more processors or controllers.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices.

If implemented in part by software, the techniques may be realized at least in part by a computer-readable data storage medium (e.g., a non-transitory computer-readable storage medium) comprising code with instructions that, when executed by one or more processors or controllers, performs one or more of the methods and functions described in this disclosure. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

The following example may provide additional details about CIP systems and techniques in accordance with this disclosure.

### Example

A variety of different CIP cleaning fluids were evaluated on standardized soiled surfaces to evaluate the impact of different water hardness levels on CIP cleaning efficacy. The experiment started by performing a standardized soil deposition procedure to deposit standardized soils on sample surfaces for evaluation.

To form the standardized soils, stainless steel beakers or cups were obtained to provide the test surfaces. The beakers were then cleaned with sodium hydroxide and rinsed with hard water (approximately 290 ppm hardness). The beakers were then filled with hard water (approximately 290 ppm hardness) and placed in a hot water bath for 60 min to condition the surface of the beakers. Thereafter, the contents of the beakers were emptied and the beakers allowed to air dry.

After drying, the beakers were filled with 2% milk and placed in a hot water bath for controlled heating. After heating, the milk from the beakers was discarded and the beakers rinsed with water. A consistent soil was formed on the sidewall surfaces of each of the beakers following this process.

To evaluate cleaning efficacy, four different cleaning solutions were prepared. Each cleaning solution was prepared using the same type and amount of alkaline cleaning chemistry. In particular, each cleaning solution was prepared to have a solution having 1 wt % sodium carbonate, 1 wt % sodium hydroxide, 200 ppm by weight surfactant, and a balance water. Each cleaning solution was different from each other cleaning solution by being formulated from water having a different hardness level. In particular, waters having the following hardness levels were used to formulate the four different cleaning solutions: 0 grains per gallon of hardness, 1 grain per gallon of hardness, 3 grains per gallon of hardness, and 5 grains per gallon of hardness.

Each cleaning solution was then poured into one of the breakers having a pre-soiled surface. A small magnetic stir bar was placed in the bottom of each beaker and rotated at approximately 250 rpm to provide a moderate amount of agitation. A hot water bath was used to maintain a temperature of approximately 65° C. during agitation. The cleaning solution in each beaker was agitated for 20 minutes, after which the contents of the beaker was discarded and the beaker allowed to dry.

An optical analysis technique was then used to evaluate the cleaning efficiency of each cleaning solution. The interior sidewall surfaces of each beaker were optically imaged. Software was used to perform a pixel-by-pixel analysis of the imaged sidewall surfaces, determining whether each pixel corresponded to a clean portion of sidewall (devoid of deposited soil) or a portion of sidewall on which soil remained. A percentage of clean after wash was then assigned to each beaker (and, correspondingly, cleaning solution) but dividing the clean surface area of the beaker to the total surface area of the beaker analyzed for cleanliness (e.g., pixels corresponding to clean surface areas divided by the total number of pixels).

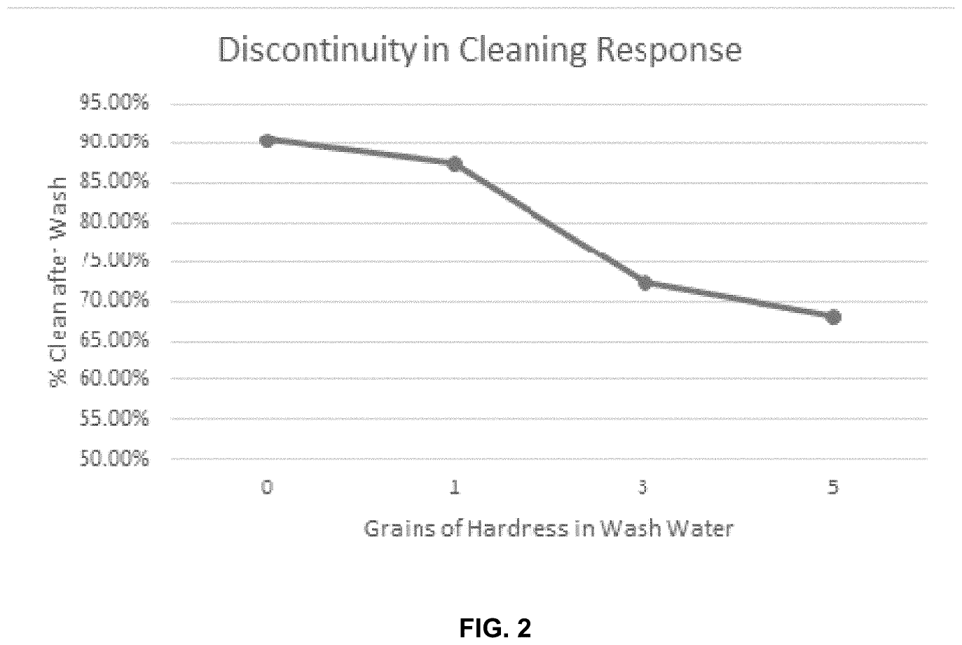

FIG. 2 is graph showing the percentage of clean after wash for the four cleaning solutions evaluated, each having different levels of hardness. The data show an inflection around two grains of hardness where the cleaning effectiveness of the solution drastically improves. To understand the extent of this inflection and behavior in the data, additional cleaning solutions were formulated from waters having different hardness levels (following the procedure outlined above), which were then tested using the process also outlined above. The following table provides the results of the testing for the different cleaning solutions:

TABLE 1
Experimental data simulating CIP cleaning effectiveness
when using waters having different hardness levels.

| Grains of Hardness | |
|---|---|
| for Water Used to | |
| Formulation | % Clean |
| Cleaning Solution | after wash |
| 0 | 92% |
| 1 | 87% |
| 2 | 82% |
| 3 | 72% |
| 4 | 70% |
| 5 | 68% |
| 6 | 66% |
| 7 | 64% |
| 8 | 62% |
| 9 | 60% |
| 10 | 58% |

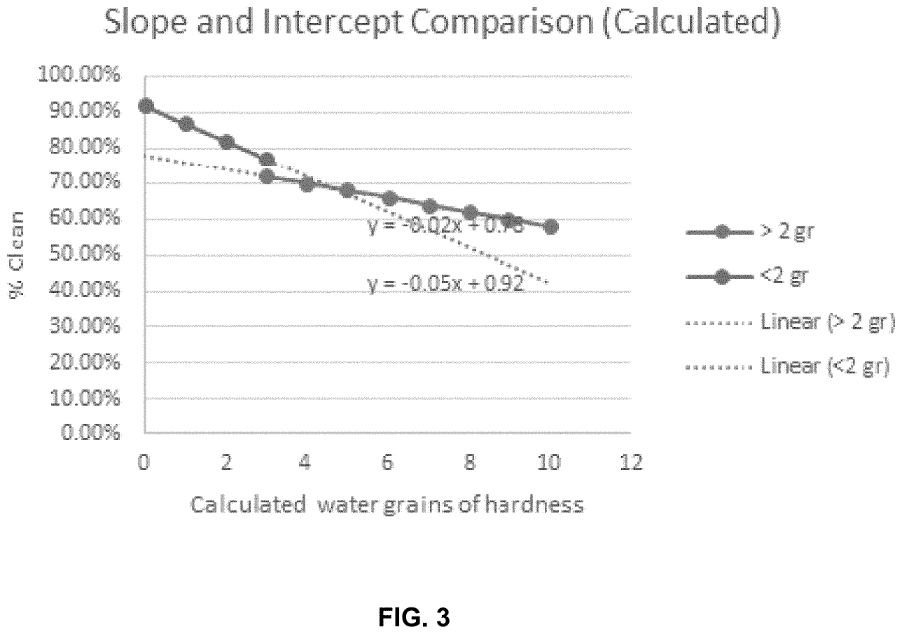

The data show a non-linear response in the cleaning performance as the hardness changes. The slope of the region between 0-1 gr is different than the slope of the region from 3-5 gr. When the functions for those lines are graphed, the difference in the slopes and intercepts are clear. The >2 grains projection, if the trend continued linearly, is 78% clean at 0 grains of hardness whereas the experimental value is 92%. FIG. 3 is a plot of experimental data with extrapolations illustrating a change in cleaning performance around 2 grains of hardness for the experimental conditions.

1. A method of performing a clean-in-place (CIP) process comprising:
receiving water from a supply source having a hardness greater than 35 parts per million;
conditioning the water from the supply source to reduce the hardness, thereby generating an ultrasoft water having a hardness less than 35 parts per million;
flushing industrial equipment with a cleaning fluid comprising at least one cleaning agent and the ultrasoft water; and
subsequent to flushing the industrial equipment with the cleaning fluid, flushing the industrial equipment with a rinse fluid to rinse the chemical agent from the industrial equipment.

2. The method of claim 1, further comprising, prior to flushing the industrial equipment with the cleaning fluid, generating the cleaning fluid by at least mixing the cleaning agent with the ultrasoft water.

3. The method of claim 1, wherein conditioning the water from the supply source comprises conditioning the water through at least one of chemical precipitation, ion exchange, and reverse osmosis.

4. The method of claim 1, wherein the water from the supply source has a hardness greater than 65 parts per million.

5. The method of claim 1, wherein the supply source is a municipal water supply.

6. The method of claim 1, wherein the cleaning fluid is lacking an effective amount of a water hardness control agent.

7. The method of claim 1, wherein the cleaning agent comprises an agent selected from the group consisting of an alkaline agent, an acidic agent, a surfactant, and combinations thereof.

8. The method of claim 7, wherein the cleaning fluid comprises:
greater than 95 weight percent of the ultrasoft water;
less than 1 weight percent of the alkaline agent or the acidic agent; and
from 0.1 to 5 weight percent of the surfactant.

9. The method of claim 1, wherein the cleaning agent comprises an alkali metal hydroxide.

10. The method of claim 1, wherein the hardness of the ultrasoft water is less than 18 parts per million.

11. The method of claim 1, wherein flushing the industrial equipment with the rinse fluid comprises flushing the industrial equipment with the ultrasoft water.

12. The method of claim 1, further comprising, prior to flushing the industrial equipment with the cleaning fluid, flushing the industrial equipment with a pre-rinse fluid.

13. The method of claim 12, wherein the pre-rinse fluid is the ultrasoft water.

14. The method of claim 1, wherein flushing the industrial equipment with the cleaning fluid comprising recirculating the cleaning fluid through the industrial equipment.

15. The method of claim 1, wherein the industrial equipment comprises industrial equipment selected from the group consisting of a tank, a pipe, a filter, a valve, a heat exchanger and combinations thereof.

16. The method of claim 15, wherein the industrial equipment is part of a plant that processes a mammalian-consumable food or beverage.

17. A system comprising:
industrial equipment having a fluid inlet and a fluid outlet;
a water conditioner configured to receive water from a supply source and reduce a hardness of the water to less than 35 parts per million, thereby generating an ultrasoft water;
a source of a cleaning agent;
a fluid pump configured to receive the ultrasoft water and the cleaning agent, pressurize a cleaning fluid comprising the ultrasoft water and the cleaning agent, and convey the pressurized cleaning fluid through the industrial equipment from the fluid inlet to the fluid outlet.

18. The system of claim 17, further comprising a cleaning fluid mix tank in fluid communication with the water conditioner and the source of the cleaning agent, the cleaning fluid mix tank being configured to receive the ultrasoft water and the cleaning agent and mix the ultrasoft water and the cleaning agent to generate the cleaning fluid, wherein the fluid pump is in fluid communication with the mix tank.

19. The system of claim 17, wherein the water conditioner is selected from the group consisting of a chemical precipitation system, an ion exchange system, a reverse osmosis system, a chemical pretreatment system, and combinations thereof, and the water conditioner is configured to reduce the hardness of the water to less than 18 parts per million.

20. The system of claim 17, wherein:
the water from the supply source has a hardness greater than 65 parts per million,
the cleaning agent comprises an agent selected from the group consisting of an alkaline agent, an acidic agent, a surfactant, and combinations thereof, and
the cleaning fluid comprises:
greater than 95 weight percent of the ultrasoft water;
less than 1 weight percent of the alkaline agent or the acidic agent; and
from 0.1 to 5 weight percent of the surfactant.

21. The system of claim 17, further comprising a controller that is configured to:
control the fluid pump to convey the cleaning fluid through the industrial equipment during a cleaning step,
prior to conveying the cleaning fluid through the industrial equipment, control the fluid pump to convey a pre-rinse fluid through the industrial equipment during a pre-rinse step, and
subsequent to conveying the cleaning fluid through the industrial equipment, control the fluid pump to convey a rinse fluid through the industrial equipment.

22. The system of claim 23, wherein at least one of the pre-rinse fluid and the rinse fluid comprises the ultrasoft water.

23. The system of claim 17, wherein the industrial equipment comprises industrial equipment selected from the group consisting of a tank, a pipe, a filter, a valve, a heat exchanger and combinations thereof.
